(19) United States
(12) Patent Application Publication
(10) Pub. No.: US 2019/0217970 A1
(43) Pub. Date: Jul. 18, 2019

(54) Wheel Clamping Cradle

(71) Applicants: Anthony Chan, Sierra Madre, CA (US); Tracy Haeggstrom, Orange, CA (US); Mayra Molina, Pomona, CA (US)

(72) Inventors: Anthony Chan, Sierra Madre, CA (US); Tracy Haeggstrom, Orange, CA (US); Mayra Molina, Pomona, CA (US)

(21) Appl. No.: 16/252,415

(22) Filed: Jan. 18, 2019

Related U.S. Application Data
(60) Provisional application No. 62/618,627, filed on Jan. 18, 2018.

(51) Int. Cl. B64F 1/22; B60D 1/01; B60D 1/14; B60D 1/28; B60D 1/58

(52) U.S. Cl. CPC B64F 1/22; B60D 1/01; B60D 1/583; B60D 1/28; B60D 1/143

(57) ABSTRACT

An aircraft tug wheel cradle with a front ramp assembly and a rear gate assembly on a base plate, each hingedly mounted and movable between a wheel-mounting position and a wheel-confining position. A first side clamp and a second side clamp are hingedly coupled to the base plate on opposing sides of the vehicle wheel, and movable between a lower position and an upper position coinciding with the wheel-confining position. The first side clamp and the second side clamp are each preferably hingedly attached to the base plate at other than an ninety degree angle in order to grasp the vehicle wheel, such that the vehicle is prevented from lateral and upward, as well as front and back movement.

### BACKGROUND

The present apparatus generally relates to mechanical securing of vehicle wheels. More specifically, the present invention relates to a wheel clamping cradle design for holding a vehicle wheel in place.

Various vehicle wheel securing devices, for example a tug apparatus for the front wheel of an aircraft, are known in the art. These apparatus typically comprise a low, wheeled platform capable of supporting and securely holding the aircraft wheel. The apparatus is either on-board or is connected to another vehicle, either motorized or non-motorized. When the aircraft wheel is driven onto the wheel securing apparatus and anchored in position, the apparatus can be maneuvered according to preference by a user, thereby allowing the aircraft to be towed to a suitable location, such as a hangar, maintenance facility or other appropriate location.

Since a tug apparatus usually pulls an aircraft by the front wheel, and due to the relatively heavy nature of even small aircraft, considerable resistance builds up at the interface between the front wheel and the wheel securing device aboard the tug apparatus. For this reason, wheel securing devices typically include a ramp that an aircraft wheel can roll up, a platform on which the wheel rests, and a gate or similar structure opposite the ramp to confine the wheel. In many instances, the gate and ramp may be hingedly affixed to the wheel securing device, such that the aircraft wheel pushing the gate forward causes the ramp to rotate up and confine the wheel between it and the gate. Since aircraft tend to be lighter at the nose and heavier toward the wings and rear, the resistance building up from laterally towing an aircraft may promote the front wheel not securely engaging the wheel securing device and also possibly lifting up when towed. A problem with existing devices is that while they prevent forward and backward rolling movement of the aircraft wheel using a gate and hinged ramp, they do not effectively provide lateral confinement for the wheel, and do not prevent the wheel from lifting up from the tow apparatus.

Hence, what is needed is a wheel clamping cradle for a vehicle wheel, such as an aircraft wheel, that provides more stable securing of the wheel, both laterally and by preventing lifting, without the limitations of existing techniques.

SUMMARY

In a primary embodiment, a wheel clamping cradle apparatus is disclosed for confining a vehicle wheel (such as an aircraft front wheel onboard an aircraft tug. The apparatus is principally composed of a base plate having a resilient flat surface for accommodating the vehicle wheel. A front ramp assembly is hingedly coupled to the base plate, and the front ramp assembly is movable between a lowered position for accepting the vehicle wheel, and a raised position for confining the vehicle wheel. In similar fashion, a rear gate assembly is also hingedly coupled to the base plate, and the rear gate assembly is movable between a forward position for accepting the vehicle wheel, and a rearward position for confining the vehicle wheel.

A first side clamp is provided, hingedly coupled to the base plate, but also hingedly coupled to the front ramp assembly. In similar fashion, a second side clamp is hingedly coupled to the base plate and the front ramp assembly. The first side clamp and the second side clamp are arranged on the base plate such that the vehicle wheel is positioned between the first side clamp and the second side clamp. By virtue of the two hinged connections, the first side clamp and the second side clamp are configured to pivot relative to the base plate, and in tandem with the rear gate assembly and front ramp assembly, such that transit of the rear gate assembly from the forward position to the rearward position causes the first side clamp and the second side clamp to move from a lowered position to a raised position.

wherein the first side clamp and the second side clamp are hingedly coupled to the base plate at an angle, such that in the raised position, the first side clamp and the second side clamp confine the vehicle wheel. To assist in this operation, the front ramp assembly may also include a front ramp roller for engaging and turning with the vehicle wheel. Similarly, the rear gate assembly may also include a rear gate roller for engaging and turning with the vehicle wheel as necessary.

The rear gate assembly preferably also includes a retaining rod to which the first side clamp and the second side camp are anchored. In order to facilitate the first side clamp and the second side clamp rotating at an angle relative to the vehicle wheel, the first side clamp and the second side clamp preferably each comprise a slot for anchoring to the rear gate assembly. Preferably, the retaining rod extends through, and slides along each slot as the first side clamp and the second side clamp are raised and lowered.

In a second embodiment, the apparatus may be characterized as a wheel clamping cradle apparatus for confining a vehicle wheel, including a base plate having a front ramp assembly, and a rear gate assembly distal from the front ramp assembly, for positioning the wheel between them. A first linkage and a second linkage are provided, with the first linkage and a second linkage coupling the front ramp assembly to the rear gate assembly, such that the front ramp assembly and the rear gate assembly move in tandem.

In this embodiment, the first side clamp and a second side clamp, each hingedly coupled to the base plate and the rear gate assembly, are installed on opposing sides of the vehicle wheel and hinged at the base plate such that they swing inward toward the vehicle wheel when raised. Additionally, the first side clamp and the second side clamp are configured to be in a lowered, non-wheel confining position when the front ramp assembly is lowered, and configured to move to a raised, wheel-confining position when the front ramp assembly is raised. Preferably, the first side clamp and the second side clamp are hingedly coupled to the base plate at complimentary angles, such that they move to the wheel-confining position when raised. The rear gate assembly preferably includes a retaining rod to which the first side clamp and the second side camp are anchored, and the first side clamp and the second side clamp each have a slot for anchoring to the rear gate assembly. For ease of loading and unloading, the front ramp assembly also includes a front ramp roller for engaging the vehicle wheel, and the rear gate assembly further comprises a rear gate roller for engaging the vehicle wheel.

In yet another embodiment, the apparatus may be characterized as having a front ramp assembly and a rear gate assembly on a base plate for holding the vehicle wheel, with the front ramp assembly and the rear gate assembly each hingedly mounted and movable between a wheel-mounting position and a wheel-confining position. A first side clamp and a second side clamp are hingedly coupled to the base plate on opposing sides of the vehicle wheel, and movable between a lower position and an upper position. The upper position is configured to coincide with the wheel-confining position of the front ramp assembly and the rear gate assembly, such that the vehicle is prevented from lateral and upward, as well as front and back movement.

Preferably at least one linkage between the front ramp assembly and the rear gate assembly, causing them to move in tandem. The rear gate assembly preferably includes a retaining rod for attaching the first side clamp and the second side clamp, and the first side clamp and the second side clamp preferably each comprise a slot for coupling to the rear gate assembly. By engaging the retaining rod with the slots, the first side clamp and the second side clamp are preferably each hingedly attached to the base plate at other than an ninety degree angle for grasping the vehicle wheel.

### BRIEF DESCRIPTION OF THE FIGURES

FIG. 1 illustrates a perspective view of a wheel clamping cradle according to the present invention;

FIG. 2 illustrates a perspective view of a vehicle wheel traveling onto the cradle, with the cradle in an unlocked configuration for accepting the wheel;

FIG. 3 illustrates a perspective view of the vehicle wheel having travelled onto the cradle, with the cradle in a locked configuration, locking the vehicle wheel into position;

FIG. 4 illustrates a front elevational view of the locked vehicle wheel, with the front ramp assembly removed, including the confining positions of a first side clamp and second side clamp engaging the vehicle wheel; and

FIG. 5 illustrates a side view of the locked vehicle tire, including the confining positions of the first side clamp engaging the vehicle wheel.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

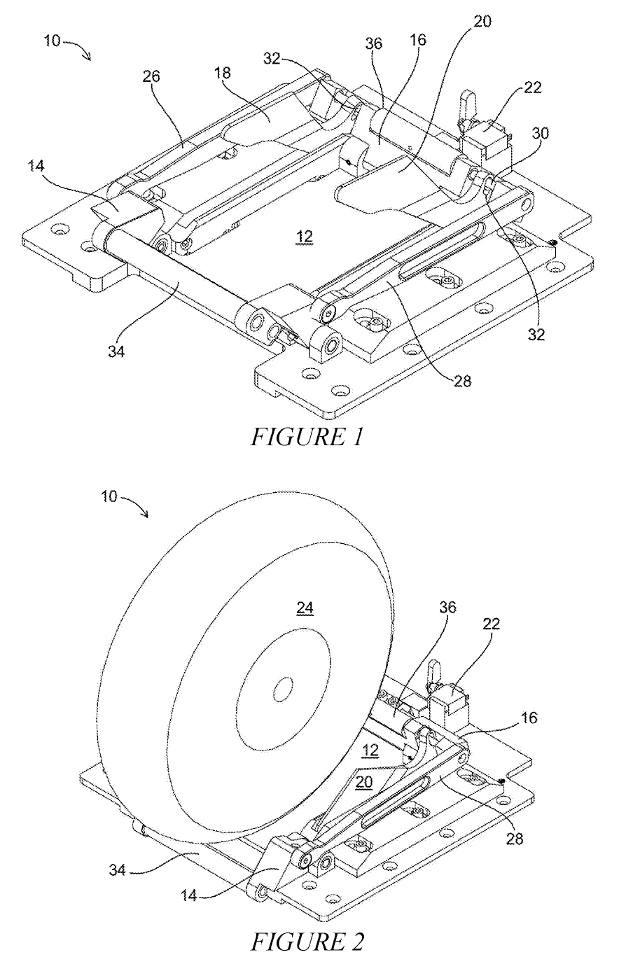

Referring to FIG. 1, the components of the wheel clamping cradle (“cradle”) 10 are shown. The cradle 10 preferably includes a base plate 12, a front ramp assembly 14, a rear gate assembly 16, a first side clamp 18, a second side clamp 20, and a latch mechanism 22. The base plate 12 is preferably a resilient flat surface upon which a vehicle wheel 24 (FIG. 2), such as an aircraft vehicle wheel may rest. Preferably, when the front ramp assembly 14 is moved to the upward position shown in the figure, the rear gate assembly 16 is urged forward, and the first side clamp 18 and the second side clamp 20 are simultaneously moved to positions upward and inward (i.e., toward one another) in order to capture the vehicle wheel 24 and thus lock it in position.

This locked configuration is preferably maintained by operation of the latch mechanism 22, which may capture the latches rear gate assembly 16 in its forward position, thus preserving the front ramp assembly 14 in its upward position, and the first side clamp 18 and the second side clamp 20 in their raised (i.e., wheel confining) positions, respectively. The first side clamp 18 and the second side clamp 20 are coupled to a retaining rod 30 of the rear gate assembly 16. Rather than being mounted at ninety degrees to the base plate 12 and retaining rod 30, the first side clamp 18 and the second side clamp 20 are mounted at oblique angles thereto. Thus, to allow for angled up and down travel, the first side clamp 18 and the second side clamp 20 are coupled to the retaining rod 30 using slots 32, along which the retaining rod travels as the first side clamp 18 and the second slide clamp 20 are raised and lowered. In one preferred embodiment, the front ramp assembly 14 may incorporate one or more front ramp rollers 30, and the rear gate assembly 16 may incorporate one or more rear gate rollers 32, as is known in the art for assisting capturing of the vehicle wheel 24.

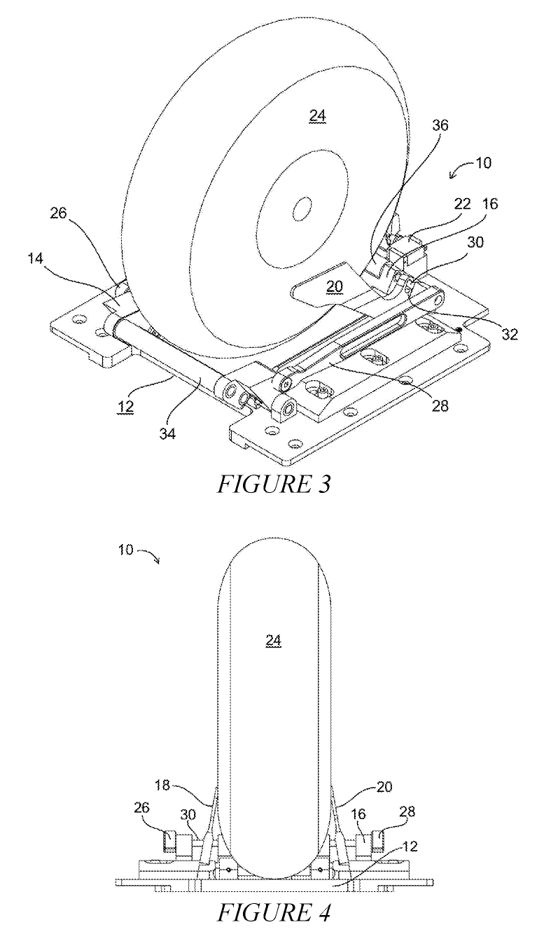

Referring to FIG. 2, the cradle 10 is in an unlocked position with the first side clamp 18 (not shown) and the second side clamp 20 in their lowered positions, respectively. The front ramp assembly 14, rear gate assembly 16, first side clamp 18 and second side clamp 20 all preferably move in tandem by virtue of a first linkage 26 (FIG. 4) connecting the front ramp assembly 14 to the rear gate assembly 16 proximal the first side clamp 18, and a second linkage 28 connecting the front ramp assembly 14 to the rear gate assembly 16 proximal the second side clamp 20. The front ramp assembly 14 is hingedly attached, or otherwise coupled to the base plate 12 in a hinged configuration allowing it to swing upward relative to the base plate 12 when the vehicle wheel 24 urges the rear gate assembly 16 forward, thus confining the vehicle wheel 24 therebetween. Likewise, the first linkage 26 and the second linkage 28 are preferably individually hingedly connected to the front ramp assembly 14.

Movement of the front ramp assembly 14 from the illustrated down position to a raised position (see FIGS. 3 and 4) causes both the first linkage 26 and the second linkage 28 to move upward and away from the base plate 12, and move toward the latch mechanism 22. The rear gate assembly 16 is also preferably hingedly connected to the base plate 12, allowing it to swing between a first position away from the latch mechanism 22 as illustrated, and a second position toward the latch mechanism 22, as shown in FIG. 3, ultimately allowing the latch mechanism 22 to directly or indirectly engage the rear gate assembly 16. The first linkage 26 and the second linkage 28, are preferably also individually hingedly coupled or otherwise connected to the rear gate assembly 16, each by a second linkage 28 hinged connection, such that any forward movement of the first linkage 26 and the second linkage 28 caused by forward and upward rotation of the front ramp assembly 14, is translated into movement of the rear gate assembly 16 toward the latch mechanism 22.

Still referring to FIG. 2, The first linkage 26 and the second linkage 28 are also preferably rotatably connected to the first side clamp 18 and the second side clamp 20, respectively, at a point between each of their connections to the front ramp 14 and the rear gate 16. The first side clamp 18 and the second side clamp 20 are coupled, or hingedly connected to the rear gate assembly 16 with the retaining rod 32 extending through the slots 32, such that rising movement of the first linkage 26 and the second linkage 28, causes a corresponding rising movement in first side clamp 18 and the second side clamp 20, driving them upward.

The first side clamp 18 and the second side clamp 20 are preferably hingedly angled relative to the base plate 12 such that their upward movement, when drawn forward by the retaining rod 30, corresponds with an inward movement toward each other (i.e., toward the vehicle wheel 24). Thus, in a raised position, the first side clamp 18 and the second side clamp 20 engage the vehicle wheel 24, locking it in position both laterally and in its rolling direction, as well as preventing it from lifting off the base plate 12. In the illustrated exemplary embodiment, at least one set of hinged connections of the first linkage 26 and the second linkage 28 to the rear gate assembly 16, as well as the hinged connections of the first linkage 26 and the second linkage 28 to the front ramp assembly 14 fall along substantially parallel axes.

Referring to FIG. 3, the vehicle wheel 24 is shown fully installed on the cradle 10. Optionally, in one embodiment, portions of the rear gate assembly 16 include a rear gate roller 36 which is cylindrical and configured such that as the vehicle wheel 24 encounters the rear gate assembly 16, the rear gate roller 36 is able to contact with the vehicle wheel 24 and turn with it as the vehicle wheel 24 pushes the rear gate assembly 16 toward the latch 22. As shown, with the rear gate assembly 16 engaged by the latch 22, the front ramp assembly 14 is held in a raised position by the first linkage 26 and the second linkage 28, and the retaining rod 30 has raised the first side clamp 18 and the second side clamp 20 into the upward, wheel confining position. Due to the angled hinged connections at the base plate, the first side clamp 18 and the second side clamp 20 have moved toward each other, thus capturing the vehicle wheel 24 between them.

Referring to FIG. 4, the wheel-engaged view of FIG. 3 is shown as an elevational front view to more clearly illustrate the confining configuration of the first side clamp 18 and the second side clamp 20. The first side clamp 18 and the second side clamp 20, and the first linkage 26 and the second linkage 28, may be installed at varying distances apart on the base plate 12, thus allowing the cradle 10 to accommodate a variety of vehicle wheels 24 having varying widths. Additionally, this may be accomplished by altering the angle of the first side clamp 18 and the second side clamp 20 relative to the

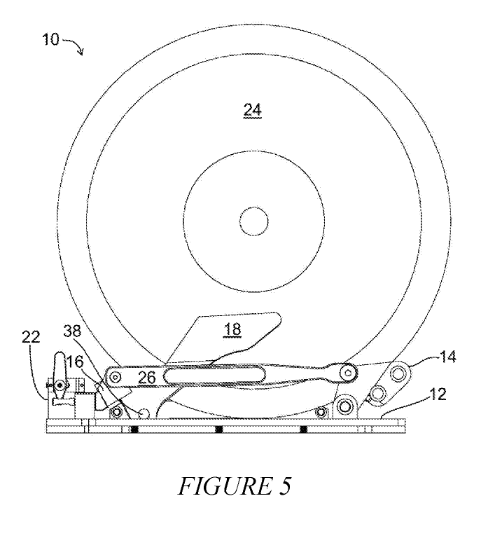

Referring to FIG. 5, the relationship between the first side clamp 18 and the first linkage 26 is shown, with the relationship between the second side clamp 20 and the second linkage 28 (not shown) being a substantially similar arrangement. In one preferred embodiment, the first side clamp 18 and the second side clamp 20 are not only hingedly connected or coupled to the rear gate 16, but also anchored or otherwise coupled in a hinged arrangement to the base plate 12. In the illustrated embodiment, the first side clamp 18 is anchored to the base plate using a pin 38. Mounted at an angle, the pin 38 causes the first side clamp 18 to move toward the vehicle wheel 24 as it rises away from the base plate 12. Preferably, a similarly mounted pin 38 anchors the second side clamp 20 in a similar fashion. Thus, the first side clamp 18 and the second side clamp 20 are able to rock back and forth while being securely prevented from sliding back and forth along the base plate 12 as the rear gate 16 moves, and thus forcing their distal ends to swing upward and capture the vehicle wheel 24 as it moves the rear gate 16 toward the latch 22.

The structure and apparatus of the wheel clamping cradle having been shown and described, its method of operation will now be discussed. The cradle 10 is used to hold a vehicle wheel 24 in place to allow minimal movement in an up and down direction, a forward and backward direction and in a side-to-side direction. The cradle 10 design holds the vehicle wheel 24 in place without any additional mechanisms permanently attaching to the cradle 10 to the vehicle wheel 24, and can be adjusted to accommodate various sizes of tires and wheels by adjusting the spacing of the first side clamp 18 and the second side clamp 20, and the first linkage 26 and the second linkage 28. The cradle 10 can be designed as a single integrated mechanism with mechanical linkages connecting multiple functioning components together or can be designed as a group of functioning components working separately through the use of actuators, levers and motors.

In addition to aircraft, the cradle 10 can be mounted on a variety of different mobile devices that need to be secured to a wheel of a secondary mobile device for facilitating towing the secondary mobile device. The cradle 10 can also be mounted in a stationary location to secure a wheel of a mobile device simply to eliminate movement of the mobile device (i.e., as a docking station).

To begin operation, the vehicle wheel 24 rolls up the front ramp assembly 14 when the front ramp assembly 14 is in the down position, and continues rolling up the front ramp assembly 14 and onto the base plate 12. When the front ramp assembly 14 is in the down position, the rear gate assembly 16 is in a forward position (i.e., away from the latch mechanism 22), and the first side clamp 18 and second side clamp 20 are in their lowered and retracted positions, respectively, as shown in FIG. 2.

As the vehicle wheel 24 continues to roll, it will eventually make contact with the rear gate assembly 16. When the vehicle wheel 24 makes contact with the rear gate assembly 16, it applies force against the rear gate assembly 16 causing the rear gate assembly 16 to be moved with the vehicle wheel 24 in the loading direction (i.e., toward the latch mechanism 22). As the rear gate assembly 16 moves in the loading direction, it causes the front ramp assembly 14 to be rotated up by virtue of the first linkage 26 and the second linkage 28 connecting the rear gate assembly 16 to the front ramp assembly 14. As the front ramp assembly 14 rotates up, it causes the first linkage 26 and the second linkage 28 to move away from the base plate 12. Thus, as the rear gate assembly 16 moves into a confining position, the first side clamp 18 and the second side clamp 20 are rotated upward at a slightly inward angle via the retaining rod 30 toward the vehicle tire 24, thus confining the sides of the vehicle tire 24 as shown in FIGS. 3, 4, and 5. The first side clamp 18 and the second side clamp 20 can be adjusted toward the vehicle wheel 24 such that when they are in the fully raised and inward positions, they contact the vehicle wheel 24 on opposite sides of the vehicle wheel 24 with a desired pressure.

The latch mechanism 22 will catch the rear gate assembly 16 in a fully loaded position, such that the cradle 10 will lock the vehicle wheel 24 in the loaded position with the front ramp assembly 14 raised up and the first side clamp 18 and second side clamp 20 both applying force on both sides of the vehicle wheel 24. The front ramp assembly 14 and the rear gate assembly 16 are preferably spaced to keep the vehicle wheel 24 from moving forward and backward. The first side clamp 18 and the second side clamp 20 come together to keep the vehicle wheel 24 from moving from side to side. Additionally, the first side clamp 18 and the second side clamp 20 also keep the vehicle wheel 24 from being lifted off the base plate 12. In one embodiment, the prevention of lifting may be due to the first side clamp 18 and the second side clamp 20 engaging and following the inward profile of the vehicle wheel 24 tire. In other embodiments, the first side clamp 18 and the second side clamp 20 may engage the hub of the vehicle wheel 24 in various preferred configurations.

In one preferred embodiment, the cradle 10 is designed for use on an aircraft tug. Preferably, the cradle 10 is secured on top of the tug and the vehicle wheel 24 (i.e., the front wheel of an aircraft) is loaded in position as described above, so that the tug can pull or push the airplane according to preference. In other embodiments, it is anticipated the cradle 10 can be used for other tug type devices such as car moving tugs or trailer moving tugs. In additional embodiments, it is anticipated the cradle 10 can also be used as a secure holder for bicycles and motorcycles on a trailer or when installed in a rack.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A wheel clamping cradle apparatus for confining a vehicle wheel onboard an aircraft tug, the apparatus comprising:
a base plate comprising a resilient flat surface for accommodating the vehicle wheel;
a front ramp assembly hingedly coupled to the base plate, the front ramp assembly movable between a lowered position for accepting the vehicle wheel, and a raised position for confining the vehicle wheel;
a rear gate assembly hingedly coupled to the base plate, the rear gate assembly movable between a forward position for accepting the vehicle wheel, and a rearward position for confining the vehicle wheel;
a first side clamp hingedly coupled to the base plate and the front ramp assembly, and a second side clamp hingedly coupled to the base plate and the front ramp assembly, such that the vehicle wheel is positioned between the first side clamp and the second side clamp;
the first side clamp and the second side clamp configured to pivot relative to the base plate, such that transit of the rear gate assembly from the forward position to the rearward position causes the first side clamp and the second side clamp to move from a lowered to a raised position; and
wherein the first side clamp and the second side clamp are hingedly coupled to the base plate at an angle, such that in the raised position, the first side clamp and the second side clamp confine the vehicle wheel.

2. The apparatus of claim 1 wherein the front ramp assembly further comprises a front ramp roller for engaging the vehicle wheel.

3. The apparatus of claim 1 wherein the rear gate assembly further comprises a rear gate roller for engaging the vehicle wheel.

4. The apparatus of claim 1 wherein the rear gate assembly further comprises a retaining rod to which the first side clamp and the second side camp are anchored.

5. The apparatus of claim 1 wherein the first side clamp and the second side clamp each comprise a slot for anchoring to the rear gate assembly.

6. A wheel clamping cradle apparatus for confining a vehicle wheel, the apparatus comprising:
a base plate having a front ramp assembly and a rear gate assembly distal from the front ramp assembly;
a first linkage and a second linkage coupling the front ramp assembly to the rear gate assembly, such that the front ramp assembly and the rear gate assembly move in tandem;
a first side clamp and a second side clamp, each hingedly coupled to the base plate and the rear gate assembly, the first side clamp and the second side clamp installed on opposing sides of the vehicle wheel and hinged at the base plate such that they swing inward toward the vehicle wheel when raised; and
the first side clamp and the second side clamp configured to be in a lowered, non-wheel confining position when the front ramp assembly is lowered, and configured to move to a raised, wheel-confining position when the front ramp assembly is raised.

7. The apparatus of claim 6 wherein the first side clamp and the second side clamp are hingedly coupled to the base plate at complimentary angles, such that they move to the wheel-confining position when raised.

8. The apparatus of claim 6 wherein the rear gate assembly further comprises a retaining rod to which the first side clamp and the second side camp are anchored.

9. The apparatus of claim 6 wherein the first side clamp and the second side clamp each comprise a slot for anchoring to the rear gate assembly.

10. The apparatus of claim 6 wherein the front ramp assembly further comprises a front ramp roller for engaging the vehicle wheel.

11. The apparatus of claim 6 wherein the rear gate assembly further comprises a rear gate roller for engaging the vehicle wheel.

12. A wheel clamping cradle apparatus for confining a vehicle wheel, the apparatus comprising:
a front ramp assembly and a rear gate assembly on a base plate for holding the vehicle wheel;
the front ramp assembly and the rear gate assembly each hingedly mounted and movable between a wheel-mounting position and a wheel-confining position;
a first side clamp and a second side clamp hingedly coupled to the base plate on opposing sides of the vehicle wheel, and movable between a lower position and an upper position; and
the upper position configured to coincide with the wheel-confining position of the front ramp assembly and the rear gate assembly, such that the vehicle is prevented from lateral and upward, as well as front and back movement.

13. The apparatus of claim 12 further comprising at least one linkage between the front ramp assembly and the rear gate assembly, causing them to move in tandem.

14. The apparatus of claim 12 wherein the rear gate assembly includes a retaining rod for attaching the first side clamp and the second side clamp.

15. The apparatus of claim 12 wherein the first side clamp and the second side clamp each comprise a slot for coupling to the rear gate assembly.

16. The apparatus of claim 12 the first side clamp and the second side clamp are each hingedly attached to the base plate at other than an ninety degree angle.
